(19) United States
(12) Patent Application Publication
(10) Pub. No.: US 2010/0076660 A1
(43) Pub. Date: Mar. 25, 2010

(54) VEHICLE TRACTION CONTROL SYSTEM

(75) Inventor: Heath Folk, West Bloomfield, MI (US)

Correspondence Address: HONEYWELL INTERNATIONAL INC.;PATENT SERVICES, 101 COLUMBIA ROAD, P O BOX 2245, MORRISTOWN, NJ, 07962-2245, US

(73) Assignee: Honeywell International Inc.

(21) Appl. No.: 12/236,610

(22) Filed: Sep. 24, 2008

(51) Int. Cl. B60K 28/16

(52) U.S. Cl. 701/84

(57) ABSTRACT

A traction control system that combines torque sensors with wheel speed sensors and a transmission gear with vehicle speed to help sustain maximum traction. The torque sensors generate torque value as output and the speed sensors detect the wheel speed with respect to each wheel of the vehicle. An electronic control module can be utilized to detect traction loss by analyzing the torque and the speed signals and recording the applied torque value when the traction is lost. The torque value can then be limited to a value that is immediately below the recorded torque value in order to prevent further traction loss. The system monitors traction until the speed attains a steady state in order to allow maximum torque and, therefore, maximum acceleration.

### TECHNICAL FIELD

Embodiments are generally related to vehicle traction control systems. Embodiments are also related to torque sensors. Embodiments are further related to control techniques for optimizing traction.

### BACKGROUND OF THE INVENTION

A Traction Control System (TCS) is designed to prevent loss of traction and, therefore, the control of a vehicle when excessive throttle or steering is applied by a driver. Vehicle traction controls can be utilized to sense, for example, wheel slip under non-braking conditions and control one or both of the vehicle brakes or engine to spin down the driven wheels as necessary to regain traction. The wheel spin-up activates the traction control system, which causes a reduction in engine power or a brake activation of the spun-up wheel, which in turn may reduce vehicle performance at a time when it is most demanded. It is undesirable to merely retune the traction control system to ignore the spin-up because the action of the traction control system is desirable to handle identical spin-ups encountered in non-controlled maneuvers, particularly in vehicles that may also be operated in normal, off-track driving.

The majority of prior art vehicle traction control systems utilize speed sensors to detect the loss of traction in the wheel. An anti-lock brake system (ABS), for example, may be applied to prevent wheels from locking up during panic or hard braking, or the engine torque can be reduced to regain traction. Torque is then reapplied to accelerate the vehicle, and if traction is lost again, the process repeats. Such traction loss can happen at a very high rate, but the vehicle may not be able to predict when a wheel looses traction. Hence, vehicle acceleration suffers because such traction control overcompensates and slows the vehicle too much in order to reduce traction loss.

Based on the foregoing, it is believed that a need exists for an improved vehicle traction control system and method for controlling traction loss, which allows for a maximum torque and, therefore, maximum acceleration. A need also exists for combining torque sensor signals with other currently known parameters to create a closed loop learning vehicle traction control system that optimizes maximum traction.

### BRIEF SUMMARY

The following summary is provided to facilitate an understanding of some of the innovative features unique to the embodiments disclosed and is not intended to be a full description. A full appreciation of the various aspects of the embodiments can be gained by taking the entire specification, claims, drawings, and abstract as a whole.

It is one aspect of the present invention to provide for an improved method and system for vehicle traction control.

It is another aspect of the present invention to provide for an improved closed loop learning vehicle traction control method that optimizes maximum traction.

The aforementioned aspects and other objectives and advantages can now be achieved as described herein. A traction control system that combines torque sensors with wheel speed sensors and transmission gear with vehicle speed to help sustain maximum traction is disclosed. The torque sensors generate torque value as output and the speed sensors detect wheel speed on each wheel of a vehicle. An electronic control module (ECM) can be utilized to detect traction loss by analyzing the torque and the speed signals and record the applied torque value when the traction is lost. The engine torque value can then be limited to just below the recorded torque value in order to prevent further traction loss. The system monitors traction until the speed attains a steady state in order to allow maximum torque and, therefore, maximum acceleration.

The torque sensors can include, for example, acoustic wave (e.g., SAW, BAW, etc) devices mounted on a torque transfer component of a power train system in the vehicle in order to provide an output with respect to the torque value transferred through the component. The ECM can be utilized to combine the torque sensor output with the speed sensor output to detect the exact torque level when traction is lost. The system can limit the engine torque below a particular value at which traction is lost until the speed attains a steady state, which enables the system to function as a closed loop learning system, which allows for maximum acceleration for the drive surface.

The acoustic wave torque sensors can be utilized to transfer a wireless and batteryless torque signals to the ECM. Additionally, the ECM can be trained to allow increasing torque as the vehicle speed increases. An algorithm can be employed to implement such training since the allowable torque before traction is lost will increase as the vehicle speed and transmission gear is increased. The traction loss can be monitored until the speed attains a steady state and, thereafter, the maximum torque can be allowed again until traction is lost or unless the traction control system is switched off by the driver.

### BRIEF DESCRIPTION OF THE DRAWINGS

The accompanying figures, in which like reference numerals refer to identical or functionally-similar elements throughout the separate views and which are incorporated in and form a part of the specification, further illustrate the embodiments and, together with the detailed description, serve to explain the embodiments disclosed herein.

FIG. 1 illustrates a perspective view of a vehicle having a traction control system, in accordance with a preferred embodiment;

FIG. 2 illustrates a schematic view of the vehicle of FIG. 1, in accordance with a preferred embodiment;

FIG. 3 illustrates a block diagram of a traction control system, in accordance with a preferred embodiment; and

FIG. 4 illustrates a high level flow chart of operations illustrating logical operational steps of a method for controlling the traction of a vehicle utilizing torque sensors and wheel speed sensors, in accordance with a preferred embodiment.

### DETAILED DESCRIPTION

The particular values and configurations discussed in these non-limiting examples can be varied and are cited merely to illustrate at least one embodiment and are not intended to limit the scope thereof.

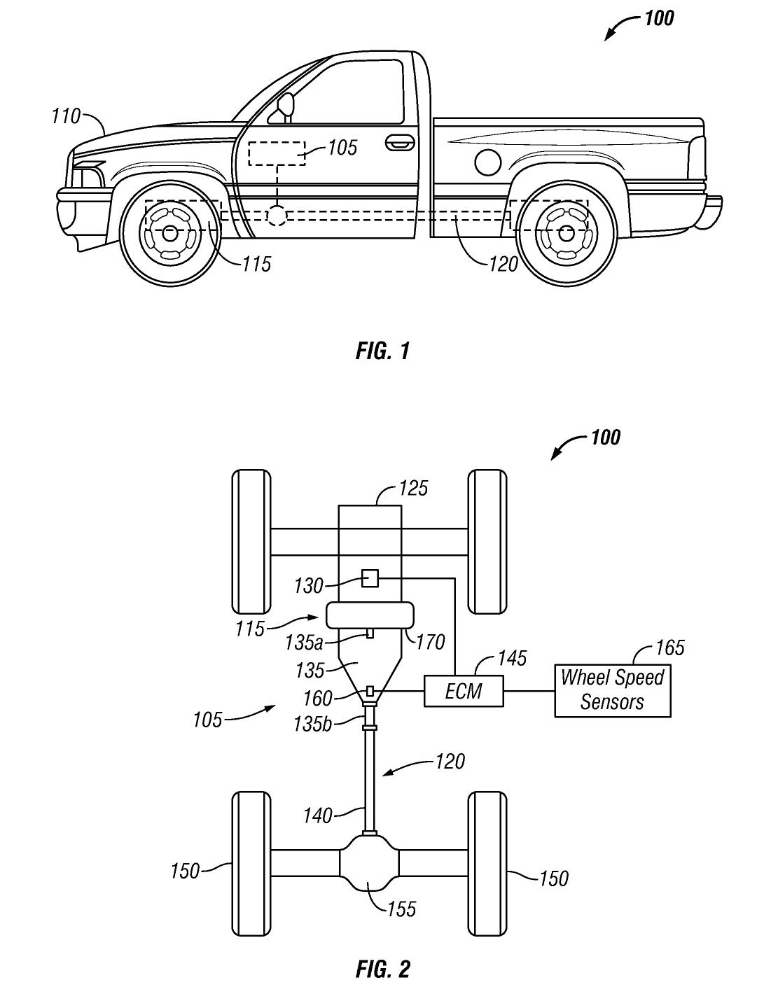

Referring to FIGS. 1 and 2, a vehicle 100 is illustrated which includes a torque sensor traction control system 105, in accordance with a preferred embodiment. The vehicle 100 generally includes a body 110, a power train 115 and a driveline 120. Note that in FIGS. 1-4, identical parts or elements are generally indicated by the same reference numerals. Note also that the embodiments discussed herein generally relate to a two-wheel drive configuration. It can be appreciated, however, that such embodiments can be implemented in the context of other vehicles having other types of drivelines, including those having more than two drive wheels. The discussion of two-wheel drive configuration, as utilized herein, is presented for general illustrative purposes only.

Thus, for example, specific components such as, for example, respective input and output shafts 135a, 135b, transmission 135 and so forth, are discussed for general illustrative purposes only and may be arranged in a different manner or in association with other vehicles and/or systems. Similarly, other types of drive systems, such as four-wheel drive configurations, can also be utilized in association with the disclosed embodiments, which are not limited to two-wheel drive systems. The two-wheel drive configuration discussed herein is thus presented for general illustrative purposes only and is not to be considered a limiting feature of the disclosed embodiments.

The example power train 115 depicted in FIGS. 1-2 includes a propulsion source, such as an internal combustion engine 125, a torque converter 170 and a transmission 135. The driveline 120 includes a prop shaft 140, a rear axle assembly 155 and a pair of drive wheels 150. The engine 125 conventionally transmits rotary power via an input shaft 135a into the torque converter 170, where the rotary output of the engine 125 is multiplied in a predetermined manner. The torque converter 170 is operable for multiplying the magnitude of a torsional load input to the transmission 135 via the input shaft 135a. The transmission 135 can include the use of one or more gear ratios that are selectively engagable to alter the speed ratio between the input shaft 135a and the output shaft 135b.

Rotary power output from the transmission 135 is delivered to the driveline 120 for distribution to the drive wheels 150. In this regard, power is transmitted through the prop shaft 140 to the rear axle assembly 155 where a differential assembly distributes the rotary power to the drive wheels 150 in a predetermined manner that is based on the construction of the differential assembly and the methodology by which it is operated.

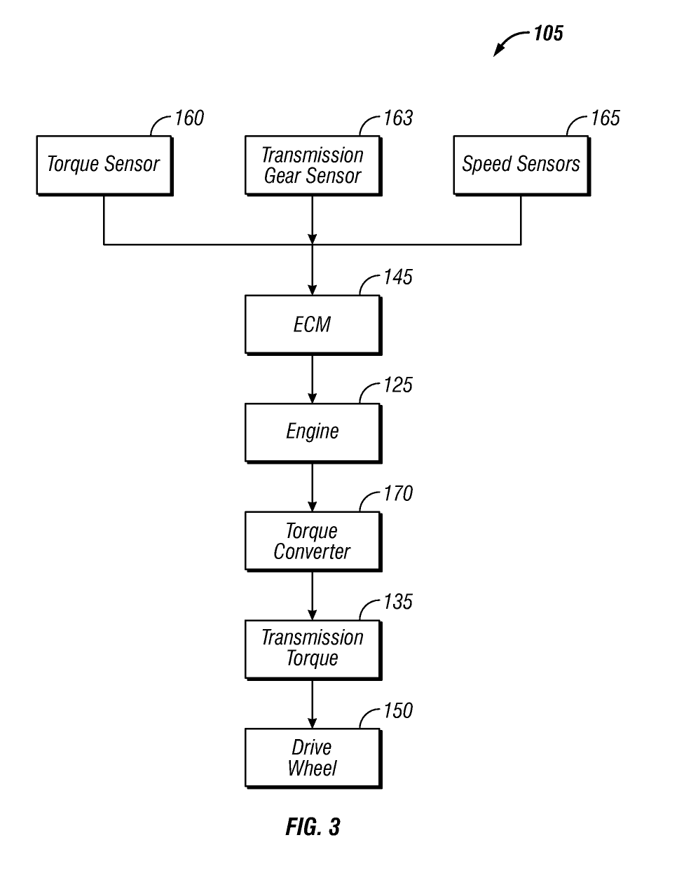

The torque sensor traction control system 105 includes an ECM (Electronic Control Module) 145 that is operably coupled to a number of torque sensors 160 and a number of wheel speed sensors 165 that are located on each wheel of the vehicle 100. The ECM 145 can also be operably coupled to a transmission gear sensor 163 (see FIG. 3). Note that the torque sensors 160 are operable for generating sensor signals indicative of various vehicle characteristics that are relevant to determine whether excess torque is being delivered by the driveline 120, as well as the extent to which excess torque is being supplied. Such characteristics may include, for example, the rotational speed of a portion of the power train 115, such as the engine crankshaft (not shown), the turbine (not shown) of the torque converter 170 or the transmission input shaft 135a, and the rotational speed of a portion of the drive line 120, such as the drive wheels 150 or the prop shaft 140.

The wheel speed sensors 165 are associated with the respective vehicle wheels which generates electric signals representative of the rotating speeds of the vehicle wheels. The torque sensors 160 can be, for example, one or more a SAW (Surface acoustic wave) sensors that are mounted on a torque transfer component of the power train 115 in the vehicle 100. It can be appreciated, of course, that the sensor signals that are generated by the torque sensors 160 and the speed sensors 165 can be transmitted to the ECM 145, either directly or via a network or data bus. An engine controller 130 can be utilized to reduce the amount of torque that is being produced by the engine 125 and thereby inhibit the wheel slip condition.

FIG. 3 illustrates a block diagram of the torque sensor traction control system 105, which can be implemented in accordance with a preferred embodiment. The system 105 can include the use of a SAW torque sensor 160, a transmission gear sensor 163, and/or one or more speed sensors 165. It is understood that such sensors 160, 163, and 165 are illustrated herein for general exemplary purposes only and are not considered limiting features of the disclosed embodiments. That is, other types of sensors may be utilized in addition to or in lieu of 160, 163, and 165 depending upon design considerations. The SAW torque sensor(s) 160 can provide an output for the torque value transferred through the torque transfer component associated with the SAW torque sensor(s) 160. The speed sensor(s) can 165 detect wheel speed on each wheel of the vehicle 100. The transmission gear sensor(s) can also be utilized in association with sensors 160 and 165 or on its own. The torque sensor(s) 160, for example, can be utilized to transfer wireless and batteryless torque signals to the ECM 145.

Note that a computer controller can also be utilized as a replacement for the ECM. ECM 145 can detect when a drive wheel loses traction (e.g., wheel speed increases above a separate wheel) by analyzing the signals generated by the torque sensors 160 and the speed sensors 165 and record the torque value applied when traction is lost. The computer controller can also be utilized to detect the exact torque level when traction is lost.

The torque of the engine 125 can then be limited through, for example, a fuel/spark curve modification and/or throttle reduction to a value that is just below the recorded torque value when traction is lost. This approach can prevent further traction loss and allow for maximum torque, and, therefore, maximum acceleration without traction loss. The traction loss can be monitored for a given period of time, or until a steady state speed is attained, indicating that acceleration is complete. Thereafter, the maximum torque can be allowed again until traction is again lost, or unless the traction control system is actually switched off by the driver. An algorithm can be employed with respect to monitoring the traction loss since the allowable torque that occurs before the traction is lost will increase as the vehicle speed and transmission gear 135 are increased. The transmission gear 135 can also be utilized in calculations of maximum allowable torque because the transmission gear 135 directly affects the ratio of torque from the engine that is delivered to the wheels.

The analysis of the ECM 145 can be transferred to the engine 125, which conventionally transmits rotary power via the input shaft 135a into the torque converter 170, where the rotary output of the engine 125 is multiplied in a predetermined manner. The torque converter 170 is operable for multiplying the magnitude of a torsional load input to the transmission 135 via input shaft 135a. The transmission 135 can include a plurality of gear ratios that are selectively engagable to alter the speed ratio between the input shaft 135a and the output shaft 135b. The rotary power output from the transmission 135 can be then delivered to the driveline 120 for distribution to the drive wheels 150.

The torque can be increased again when the speed of the vehicle 100 attains a steady rate. The traction control system 105 limits the torque of the engine 125 to a value that is just below the value at which traction is lost, until a steady state speed is reached. This approach enables the system to function as a closed loop learning system that allows a maximum acceleration for any given drive surface. If traction is lost only once, the vehicle 100 can then accelerate at a maximum torque without further traction loss and, therefore, the maximum allowable acceleration for the given road conditions.

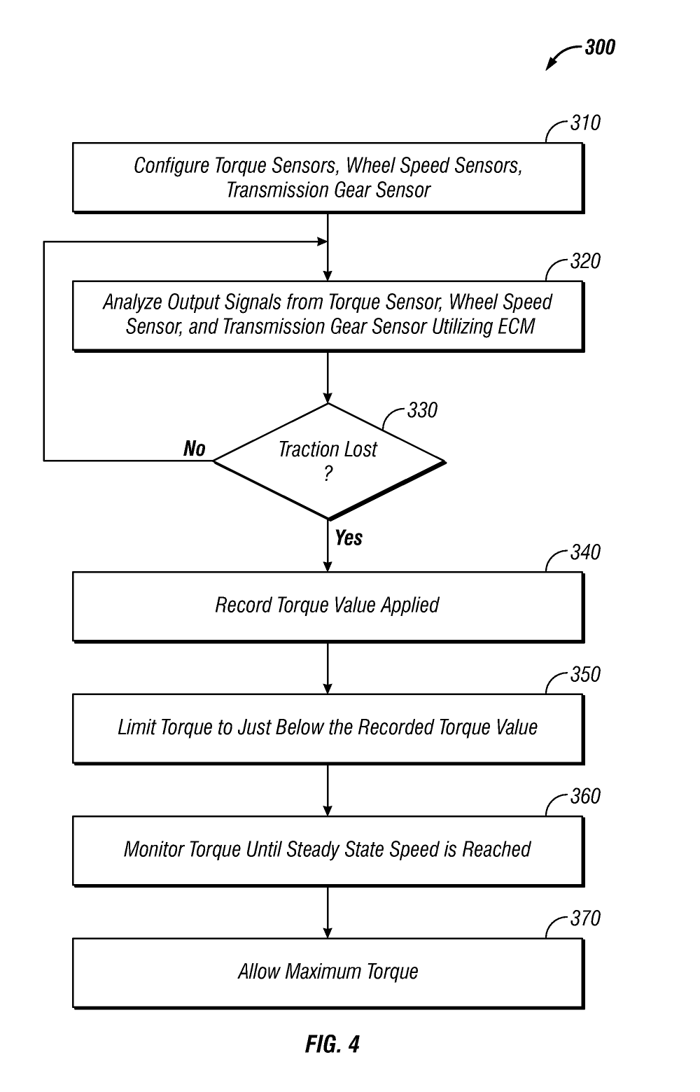

FIG. 4 illustrates a high level flow chart of operations illustrating logical operational steps of a method 300 for controlling the traction of a vehicle utilizing wheel speed sensor(s) 160, transmission gear sensor(s) 163 and/or torque sensor(s) 165, in accordance with a preferred embodiment. The torque sensor(s) 160, the transmission gear sensor(s) 163 and/or the speed sensors 16(5) can be configured, as depicted at block 310. Next, as illustrated at block 320, the output signals from the torque sensor 160 and the speed sensor 165 can be analyzed utilizing the ECM 145. Note that output signals from the transmission gear sensor 163 illustrated in FIG. 3 can also be analyzed by the ECM 145. Thereafter, as shown at block 330, the occurrence of traction can be determined. If traction is lost, the applied torque value can be recorded, as depicted at block 340. The torque can then be limited to a value that is immediately below the recorded torque value, as illustrated at block 350.

The torque value can be monitored until a steady state value is attained, as shown at block 360. Thereafter, maximum torque can be allowed again, until traction is again lost or unless the traction control system is switched off by the driver, as depicted at block 370. The torque sensor traction control system 105 can be utilized to prevent traction loss and allow maximum torque and, therefore, maximum acceleration. The torque sensor traction control system 105 can combine the SAW torque sensors 160, the wheel speed sensors 165 and/or the transmission gear sensor 163 with vehicle speed to help sustain maximum traction before traction is lost multiple times.

It will be appreciated that variations of the above-disclosed and other features and functions, or alternatives thereof, may be desirably combined into many other different systems or applications. Also, that various presently unforeseen or unanticipated alternatives, modifications, variations or improvements therein may be subsequently made by those skilled in the art which are also intended to be encompassed by the following claims.

What is claimed is:

1. A method for controlling traction, comprising:
analyzing output signals from at least one torque sensor and at least one wheel speed sensor for detecting a corresponding wheel speed with respect to at least one wheel of a vehicle;
recording a torque value applied during a traction loss and limiting a torque below said torque value in order to form a closed loop learning system that optimizes maximum traction; and
monitoring said torque for a particular period of time until a steady state speed is attained in order to allow maximum torque and, therefore, maximum acceleration to prevent further traction loss.

2. The method of claim 1 further comprising utilizing an electronic control module in order to detect said traction loss of said at least one wheel.

3. The method of claim 1 further comprising combining said at least one torque sensor with said at least one wheel speed sensor and a transmission gear sensor with respect to a speed of said vehicle in order to assist in sustaining a maximum traction before said traction is lost.

4. The method of claim 1 further comprising configuring said at least one torque sensor to comprise at least one acoustic wave device in order to transfer a wireless and batteryless torque signal to said electronic control module.

5. The method of claim 4 further comprising mounting said at least one acoustic wave device on a torque transfer component of a power train system in said vehicle in order to provide an output for a torque value transferred through said torque transfer component.

6. The method of claim 1 further comprising:
configuring said at least one torque sensor to comprise at least one acoustic wave device in order to transfer a wireless and batteryless torque signal to an electronic control module; and
mounting said at least one acoustic wave device on a torque transfer component of a power train system in said vehicle in order to provide an output for a torque value transferred through said torque transfer component.

7. The method of claim 3 further comprising:
configuring said at least one torque sensor to comprise at least one acoustic wave device in order to transfer a wireless and batteryless torque signal to an electronic control module; and
mounting said at least one acoustic wave device on a torque transfer component of a power train system in said vehicle in order to provide an output for a torque value transferred through said torque transfer component.

8. A system for controlling traction, said system comprising:
an electronic control module for analyzing output signals from at least one torque sensor and at least one wheel speed sensor for detecting a corresponding wheel speed with respect to at least one wheel of a vehicle;
a closed loop learning system associated with said electronic control module, wherein said closed loop learning system:
optimizes maximum traction, such that a torque value applied during a traction loss a torque is limited below said torque value in order to form said closed loop learning system; and
monitors said torque for a particular period of time until a steady state speed is attained in order to allow maximum torque and, therefore, maximum acceleration to prevent further traction loss.

9. The system of claim 8 wherein said electronic control module is capable of detecting a traction of said at least one wheel.

10. The system of claim 8 wherein said at least one torque sensor is combined with said at least one wheel speed sensor and a transmission gear sensor with respect to a speed of said vehicle in order to assist in sustaining a maximum traction before said traction is lost.

11. The system of claim 8 wherein said at least one torque sensor comprises at least one acoustic wave device in order to transfer a wireless and batteryless torque signal to said electronic control module.

12. The system of claim 11 wherein said at least one acoustic wave device is mounted on a torque transfer component of a power train system in said vehicle in order to provide an output for a torque value transferred through said torque transfer component.

13. The system of claim 8 wherein:
said at least one torque sensor comprises at least one acoustic wave device in order to transfer a wireless and batteryless torque signal to an electronic control module; and
said at least one acoustic wave device is mounted on a torque transfer component of a power train system in said vehicle in order to provide an output for a torque value transferred through said torque transfer component.

14. The system of claim 10 wherein:
said at least one torque sensor comprises at least one acoustic wave device in order to transfer a wireless and batteryless torque signal to an electronic control module; and
said at least one acoustic wave device is mounted on a torque transfer component of a power train system in said vehicle in order to provide an output for a torque value transferred through said torque transfer component.

15. A system for controlling traction, said system comprising:
an electronic control module for analyzing output signals from at least one torque sensor and at least one wheel speed sensor for detecting a corresponding wheel speed with respect to at least one wheel of a vehicle, wherein said electronic control module is capable of detecting a traction of said at least one wheel;
a closed loop learning system associated with said electronic control module, wherein said closed loop learning system:
optimizes maximum traction, such that a torque value applied during a traction loss a torque is limited below said torque value in order to form said closed loop learning system; and
monitors said torque for a particular period of time until a steady state speed is attained in order to allow maximum torque and, therefore, maximum acceleration to prevent further traction loss.

16. The system of claim 15 wherein said at least one torque sensor is combined with said at least one wheel speed sensor and a transmission gear sensor with respect to a speed of said vehicle in order to assist in sustaining a maximum traction before said traction is lost.

17. The system of claim 15 wherein said at least one torque sensor comprises at least one acoustic wave device in order to transfer a wireless and batteryless torque signal to said electronic control module.

18. The system of claim 17 wherein said at least one acoustic wave device is mounted on a torque transfer component of a power train system in said vehicle in order to provide an output for a torque value transferred through said torque transfer component.

19. The system of claim 15 wherein:
said at least one torque sensor comprises at least one acoustic wave device in order to transfer a wireless and batteryless torque signal to an electronic control module; and
said at least one acoustic wave device is mounted on a torque transfer component of a power train system in said vehicle in order to provide an output for a torque value transferred through said torque transfer component.

20. The system of claim 16 wherein:
said at least one torque sensor comprises at least one acoustic wave device in order to transfer a wireless and batteryless torque signal to an electronic control module; and
said at least one acoustic wave device is mounted on a torque transfer component of a power train system in said vehicle in order to provide an output for a torque value transferred through said torque transfer component.
